(19) United States
(12) Patent Application Publication
(10) Pub. No.: US 2006/0023805 A1
(43) Pub. Date: Feb. 2, 2006

(54) ASK communication device

(76) Inventors: Yo Yanagida, Shizuoka-ken (JP); Naoyuki Shiraishi, Susono-shi (JP); Atsushi Kawamura, Susono-shi (JP); Terumitsu Sugimoto, Susono-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/186,976

(22) Filed: Jul. 22, 2005

(30) Foreign Application Priority Data
Jul. 29, 2004 (JP) P2004-221987

(51) Int. Cl. H04L 27/02

(52) U.S. Cl. 375/268

(57) ABSTRACT

An ASK communication device has a carrier signal generator which is connected to a bus line which outputs carrier signals. One of ECUs, which attempts to transmit data, attenuates carrier signals superimposed on the bus line with predetermined timing by use of a transmission switch and a signal attenuator thereby to cause ASK modulation of the carrier signals. Other ECUs receive the ASK-modulated data superimposed on the bus line by use of a receiver, and obtain data by demodulating the ASK-modulated data.

### BACKGROUND OF THE INVENTION

The present invention relates to an ASK (Amplitude Shift Keying) communication device that establishes data communication between a master station and at least one slave station by using an ASK modulation scheme.

As a method of data communication between a master station and a slave station connected with each other via a bus line, the use of an ASK modulation scheme is known as disclosed, for example, in Japanese Patent Application Laid-Open No. 2002-152291.

FIGS. 1A to 1E show timing charts of data transmission and reception in a data communication method using ASK. FIG. 1A shows waveforms of carrier signals superimposed on a bus line, FIG. 1B shows data transmission and reception timing at the master station, and FIGS. 1C to 1E show data transmission and reception timing at three slave stations. In these drawings, Tx and Rx represent transmission and reception, respectively.

As shown in FIG. 1B, the master station outputs to the bus line, ID data of a transmission source station as well as communication data to send from the master station to each slave station when ID0 as a master station's ID is designated. Furthermore, as shown in FIGS. 1C to 1E, when communication data is outputted to the bus line from each slave station, the master station receives the output communication data.

Furthermore, as shown in FIG. 1C, when a slave station having ID1 as ID data is designated by the master station, the slave station of ID1 outputs to the bus line communication data to send to other slave stations and the master station.

Likewise, in FIGS. 1D and 1E, transmission data is outputted from slave stations of ID2 and ID3 to the bus line. By these operations, data communication can be achieved sequentially between the master station and each slave station.

### SUMMARY OF THE INVENTION

The conventional ASK modulation scheme, however, requires each of the master and slave stations to have an oscillator circuit. The oscillator circuit includes expensive components, such as a crystal oscillator, ceramic oscillator, or PLL circuit, which thereby increases the size of the entire device, disadvantageously leading to an increase in costs.

The present invention has been achieved in consideration of such conventional problems, and the present invention provides an ASK communication device that is useful to reduce costs by having a decreased number of oscillator circuits and thus downsized circuitry.

According to a first aspect of the present invention, there is provided an ASK communication device having a plurality of communication stations connected with each other via a bus line and establishing data communication among the communication stations by using ASK, and the ASK communication device includes a carrier signal generator connected to the bus line, the carrier signal generator outputting carrier signals to the bus line, wherein each of the communication stations includes: a modulator that transmits data by ASK modulation of attenuating the carrier signals superimposed on the bus line with predetermined timing; and a receiver that receives data transmitted from other communication stations via the bus line, one of the communication stations outputs an identification signal of a particular communication station via the bus line, and the particular communication station designated by the identification signal transmits data.

According to a second aspect of the present invention, there is provided an ASK communication device establishing data communication via a bus line, and the ASK communication device includes: a carrier signal generator connected to the bus line, the carrier signal generator outputting carrier signals to the bus line; a transmitting station that transmits data by ASK modulation of attenuating carrier signals superimposed on the bus line with predetermined timing; and a receiving station that receives the data transmitted from the transmitting station via the bus line.

### BRIEF DESCRIPTION OF THE DRAWING

FIGS. 1A to 1E are timing charts of data transmission and reception of a master station and each slave station in the case of communication using a general ASK modulation scheme;

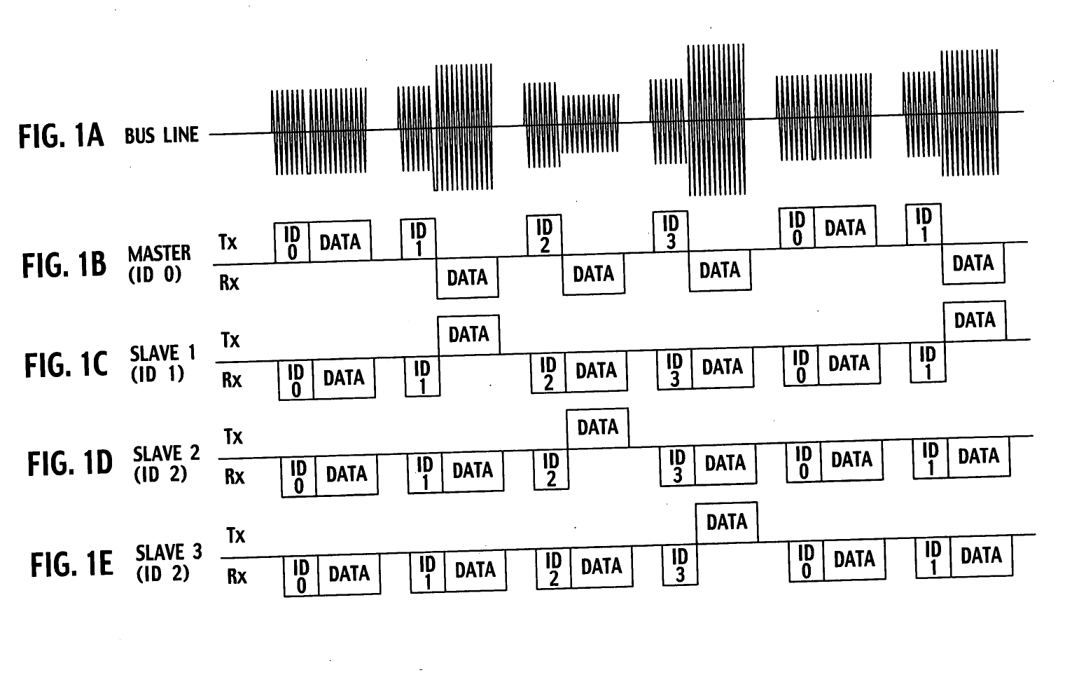

FIG. 2 is a block diagram showing the configuration of an ASK communication device according to a first embodiment of the present invention;

FIG. 3 is a circuit diagram of the ASK communication device according to the first embodiment;

FIGS. 4A and 4B are explanatory diagrams showing representations of logic “1” and “0” in the case of data communication between the master station and the slave station;

FIG. 5A is an explanatory diagram for the case where data representing a logic “1” is sent from the master station to the slave station, and FIG. 5B is an explanatory diagram for the case where data representing a logic “0” is sent from the master station to the slave station;

FIG. 6A is an explanatory diagram for the case where data representing a logic “1” is sent from the slave station to the master station, and FIG. 6B is an explanatory diagram for the case where data representing a logic “0” is sent from the slave station to the master station;

FIGS. 7A to 7F are timing charts of data transmission and reception of a master station ECU, each slave station ECU, and a J/B ECU;

FIGS. 8A to 8F are circuit diagram showing specific examples of a signal attenuator;

FIG. 9 is a block diagram of the configuration of an ASK communication device according to a second embodiment of the present invention;

FIG. 10 is a circuit diagram of the ASK communication device according to the second embodiment;

FIG. 11A is an explanatory diagram for the case where 25 data representing a logic “1” is sent from a transmitting ECU to a receiving ECU, and FIG. 11B is an explanatory diagram for the case where data representing a logic “0” is sent from the transmitting ECU to the receiving ECU;

FIG. 12 is a block diagram showing a configuration for transmitting the number of engine revolutions to a combination meter, as an example of the second embodiment;

FIGS. 13A to 13D are timing charts of data transmission and reception of an engine ECU, an engine speed sensor, and the combination meter;

FIGS. 14A and 14B are explanatory block and circuit diagrams, respectively, showing the configuration of the slave station ECU in its modification example; and

FIGS. 15A to 15E are circuit diagrams showing specific examples of an impedance element.

### DESCRIPTION OF THE PREFERRED EMBODIMENTS

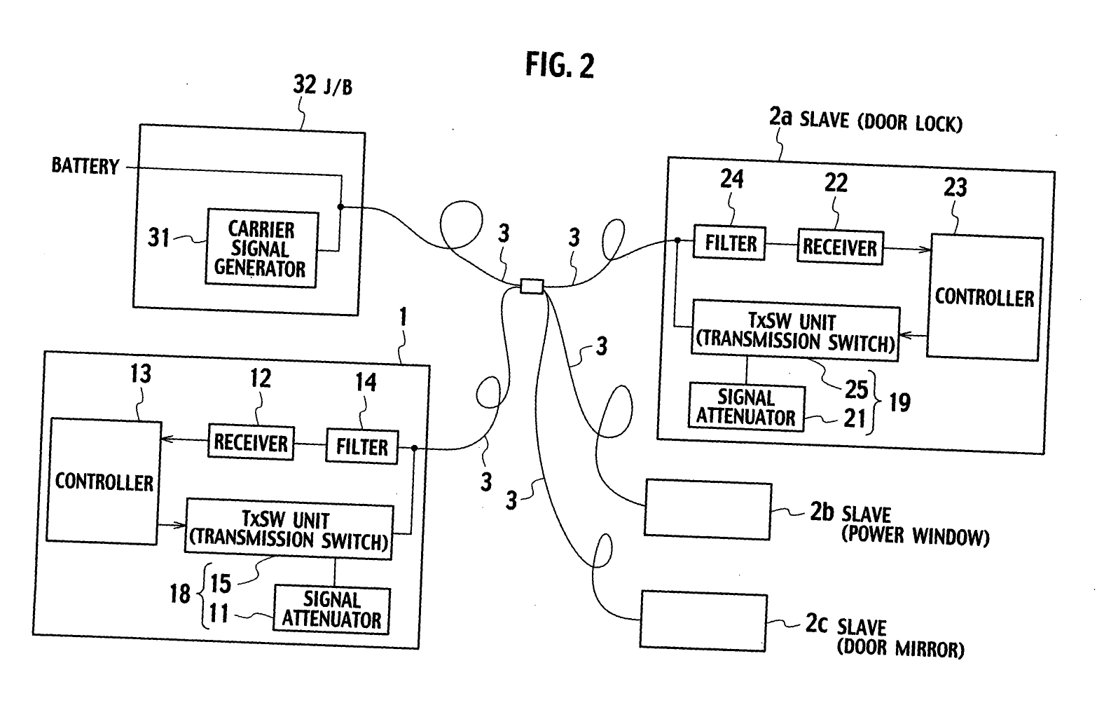

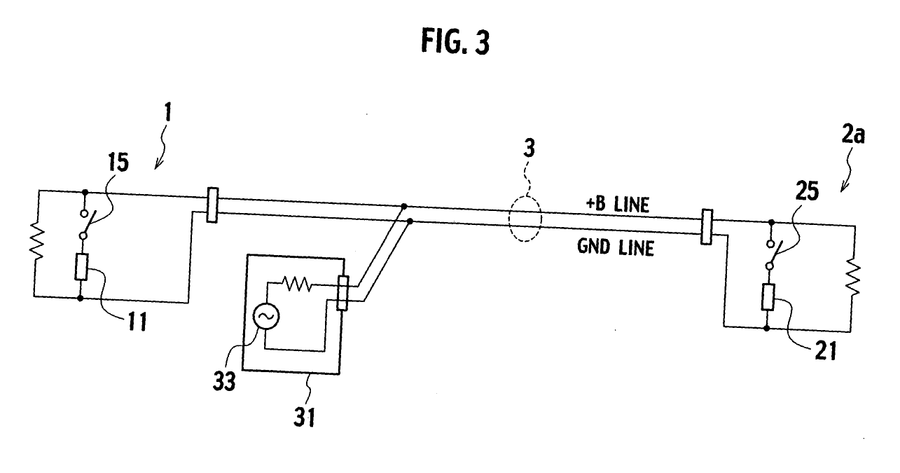

Preferred embodiments of the present invention will be explained below with reference to the accompanying drawings. FIG. 2 and FIG. 3 are a block diagram and a circuit diagram, respectively, showing a configuration of an ASK communication device according to a first embodiment of the present invention. As shown in FIG. 2, the ASK communication device establishes data communication between an ECU 1 operable as a master station and three ECUs 2a to 2c operable as a slave station by using an ASK modulation scheme.

This embodiment handles the case where PLC (Power Line Communication) technology of superimposing communication signals on a power line laid between in-vehicle ECUs (1, 2a to 2c) and battery and used to supply driving power to each of the ECUs (1, 2a to 2c) to establish data communication among those ECUs without providing a dedicated communication line. That is, the power line is used as a bus line 3 through which data communication is established among the ECUs.

The bus line 3 is connected with a J/B ECU 32 which is provided with a carrier signal generator 31 for superimposing carrier signals on the bus line 3 at a predetermined frequency. As shown in FIG. 3, the power line (bus line 3) has two electric wires of a positive +B line and a negative ground line.

The ASK communication device shown in FIG. 2 is used for communication inside a vehicle, and for example, the ECU 2a controls door locks, the ECU 2b controls power windows, and the ECU 2c controls door mirrors. The master station ECU 1 controls operational switches.

As shown in FIG. 2, the master station ECU 1 includes a modulator 18 that modulates carrier signals superimposed on the bus line 3 using ASK and a receiver 19 that demodulates received modulated signals. More specifically, the master station ECU 1 includes a signal attenuator 11 that attenuates carrier signals superimposed on the bus line 3, a transmission switch 15 that switches the signal attenuator 11 between ON and OFF states, a receiver 12 that acquires reception data by demodulating ASK-modulated signals received via the bus line 3, a filter 14 that eliminates signals within an unnecessary frequency band from the ASK-modulated signals received via the bus line 3, and a controller 13 that controls the processing executed in the receiver 12 and the operations of the transmission switch 15.

The signal attenuator 11 has impedance elements such as a capacitor. As shown in FIG. 3, a series circuit of the transmission switch 15 and the signal attenuator 11 is provided between the +B line and the ground line, so that the +B line and the ground line are connected to each other via the capacitor when the transmission switch 15 is turned ON, and as a consequence, the amplitude of the carrier signals superimposed on the +B line can be attenuated.

Each of the slave station ECUs 2a to 2c includes a receiver that receives data and demodulates the data using ASK and a modulator that modulates carrier signals superimposed on the bus line 3 using ASK. More specifically, each of the slave station ECUs 2a to 2c includes a receiver 22 that receives data transmitted via the bus line 3 and then demodulates the received data using ASK, a filter 24 that is provided on the input side of the receiver 22 and eliminates signals within an unnecessary frequency band, a signal attenuator 21 that attenuates carrier signals superimposed on the bus line 3, a transmission switch 25 that switches the signal attenuator 21 between ON and OFF states, and a controller 23 that controls the operations of the transmission switch 25 and the receiver 22. It should be noted that FIG. 2 shows the detailed configuration only of the ECU 2a and that illustrations of other ECUs 2b and 2c are omitted because they have the same configuration as that of the ECU 2a. In addition, the modulator has the transmission switch 25 and the signal attenuator 21.

The slave station ECU 2a is configured similarly to the master station ECU 1. The signal attenuator 21 has an impedance component such as a capacitor, and as shown in FIG. 3, a series circuit of the transmission switch 25 and the signal attenuator 21 is provided between the +B line and the ground line, so that the +B line and the ground line are connected to each other via the capacitor when the transmission switch 25 is turned ON, and as a consequence, the amplitude of the carrier signals superimposed on the +B line can be attenuated.

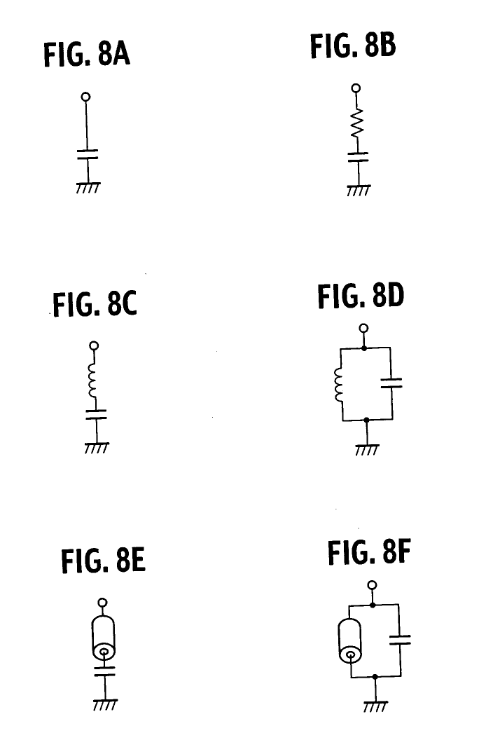

For the above described signal attenuators 11 and 21, various types of impedance circuits can be used as long as the signal attenuators 11 and 21 are provided between the +B line and the ground line and have the capability of attenuating the amplitude of high-frequency signals superimposed on the +B line. As specific examples, a capacitor shown in FIG. 8A, a series circuit of a resistor and capacitor shown in FIG. 8B, a series circuit of a coil and capacitor shown in FIG. 8C, a parallel circuit of a coil and capacitor shown in FIG. 8D, a series circuit of a ferrite bead and capacitor shown in FIG. 8E, a parallel circuit of a ferrite bead and capacitor shown in FIG. 8F, and the combinations thereof can be used for the signal attenuators 11 and 21. Furthermore, the same effect can be obtained when circuits other than the above with low impedance at a carrier frequency are used.

The carrier signal generator 31 in FIG. 2 includes an oscillator circuit 33 as shown in FIG. 3, and carrier signals outputted from the oscillator circuit 33 are superimposed on the bus line 3.

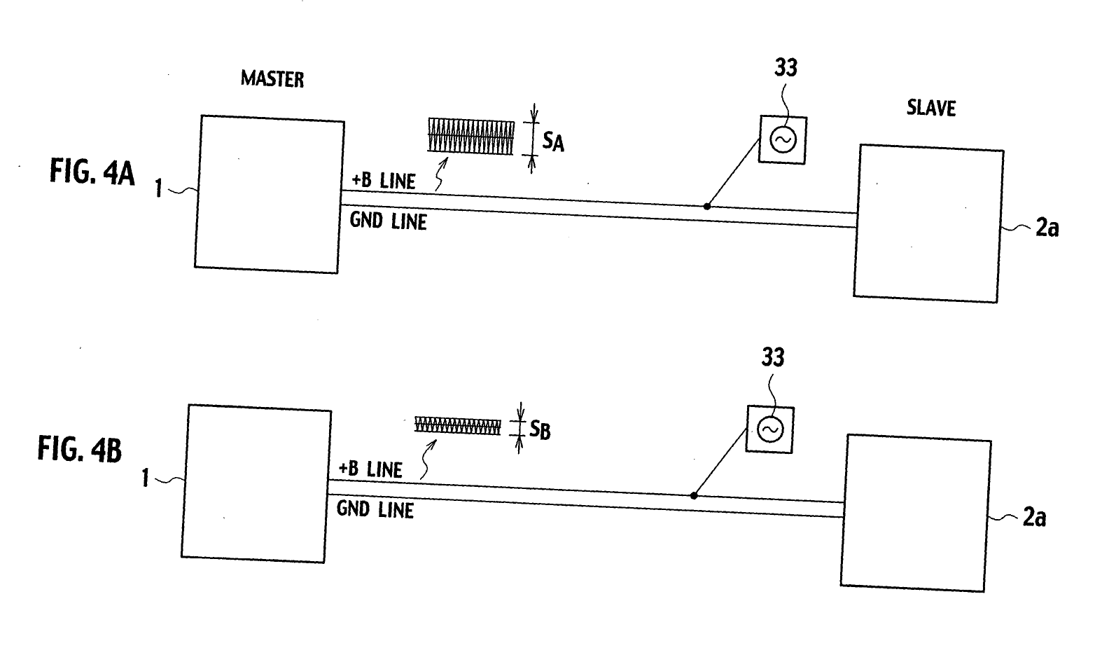

FIGS. 4A and 4B are explanatory diagrams showing representations of “1” and “0” resulting from ASK modulation of carrier signals superimposed on the bus line 3. As shown in FIG. 4A, the case S_{A} where the amplitude of carrier signals is greater than a specific value represents a logic “1”, and as shown in FIG. 4B, the case S_{B} where the amplitude of carrier signals is smaller than the specific value represents a logic “0”. Note here that this correspondence between logics “1”, “0” and amplitudes S_{A}, S_{B} may be reversed.

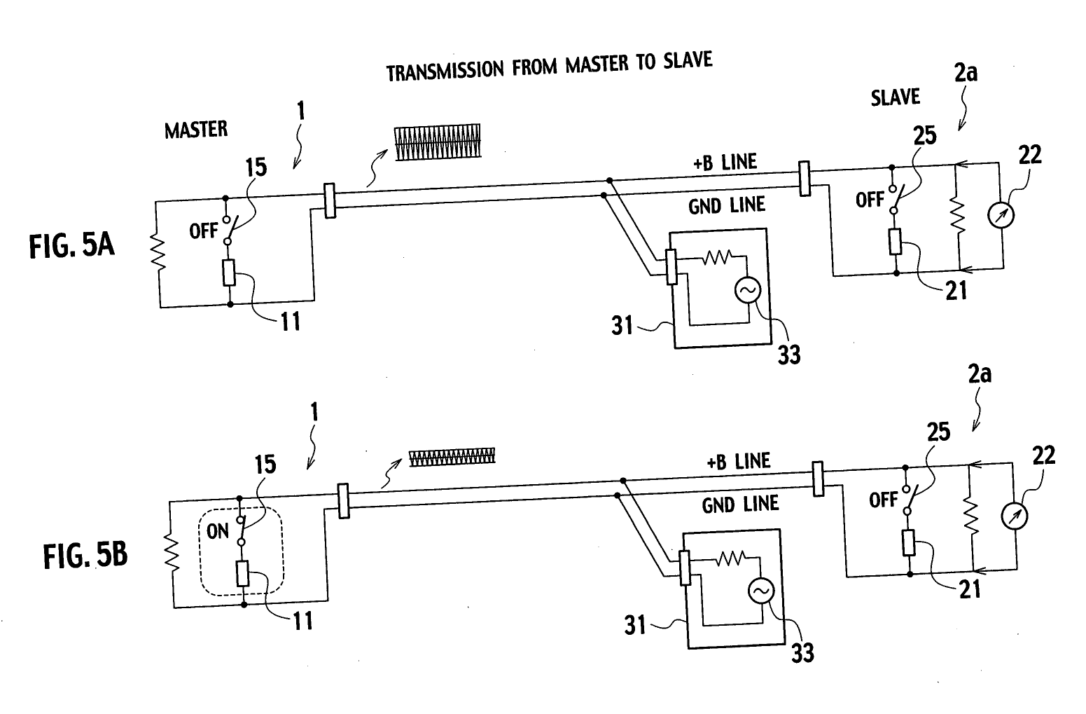

FIGS. 5A and 5B are explanatory diagrams showing operations of the transmission switch 15 performed when data is transmitted from the master station ECU1 to the slave station ECU 2a. FIG. 5A illustrates the case where “1” is represented. As shown in FIG. 5A, when the transmission switch 15 is turned OFF, the amplitude of carrier signals output from the carrier signal generator 31 of FIG. 2 and then superimposed on the bus line 3 is maintained, so that “1” can be represented.

FIG. 5B illustrates the case where “0” is represented. When the transmission switch 15 is turned ON, the +B line and the ground line are connected with each other via the signal attenuator 11, and therefore carrier signals output from the carrier signal generator 31 and superimposed on the bus line 3 are attenuated, so that the amplitude of the carrier signals becomes small. Accordingly, “0” can be represented.

That is, without the need for the master station ECU 1 to have therein an oscillator circuit for generating carrier signals and transmission means for modulating the carrier signals using ASK to output them to the bus line 3, the master station ECU 1 can send the ASK-modulated signals to each of the slave station ECUs 2a to 2c by switching the transmission switch 15 between ON and OFF states.

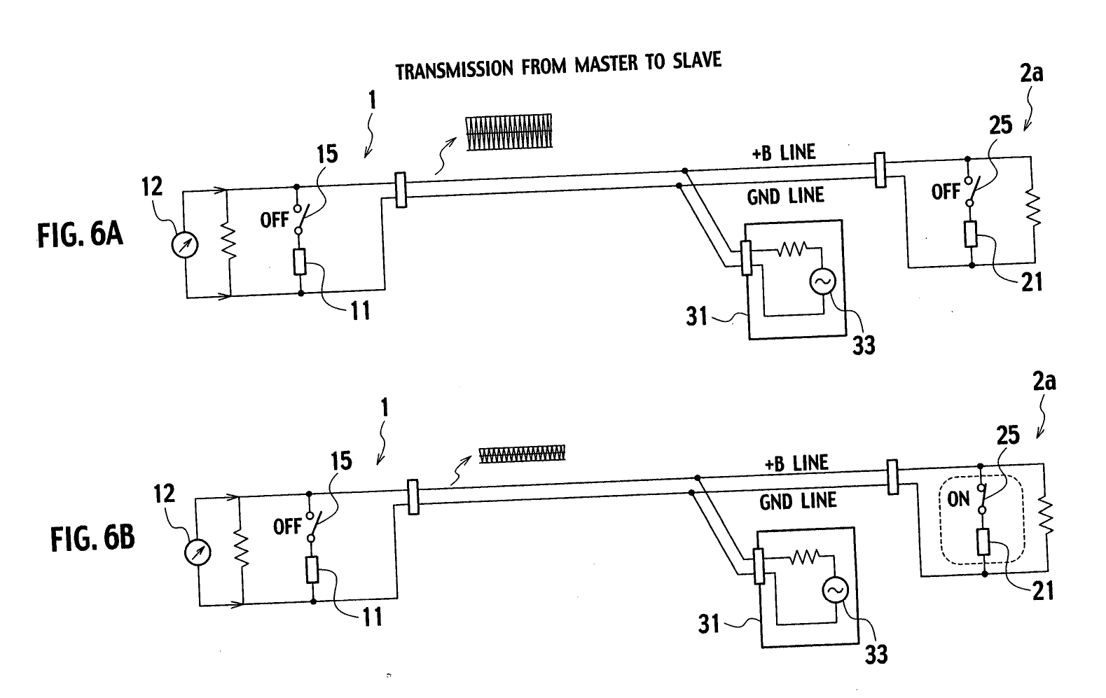

FIGS. 6A and 6B are explanatory diagrams showing the operations of the transmission switch 25 performed when data is transmitted from the slave station ECU 2a to the master station ECU 1. FIG. 6A illustrates the case where “1” is represented. As shown in FIG. 6A, when the transmission switch 25 is turned OFF, the amplitude of carrier signals output from the carrier signal generator 31 of FIG. 2 and superimposed on the bus line 3 is maintained, so that “1” can be represented.

FIG. 6B illustrates the case where “0” is represented. When the transmission switch 25 is turned ON, the +B line and the ground line are connected with each other via the signal attenuator 21, and therefore the carrier signals output from the carrier signal generator 31 and superimposed on the bus line 3 are attenuated, so that the amplitude of the carrier signals becomes small. Accordingly, “0” can be represented.

That is, just like the foregoing master station ECU1, without having an oscillator circuit and transmission means, the slave station ECU 2a can transmit the ASK-modulated signal to the master station ECU 1 and other slave stations by ON and OFF operations of the transmission switch 25.

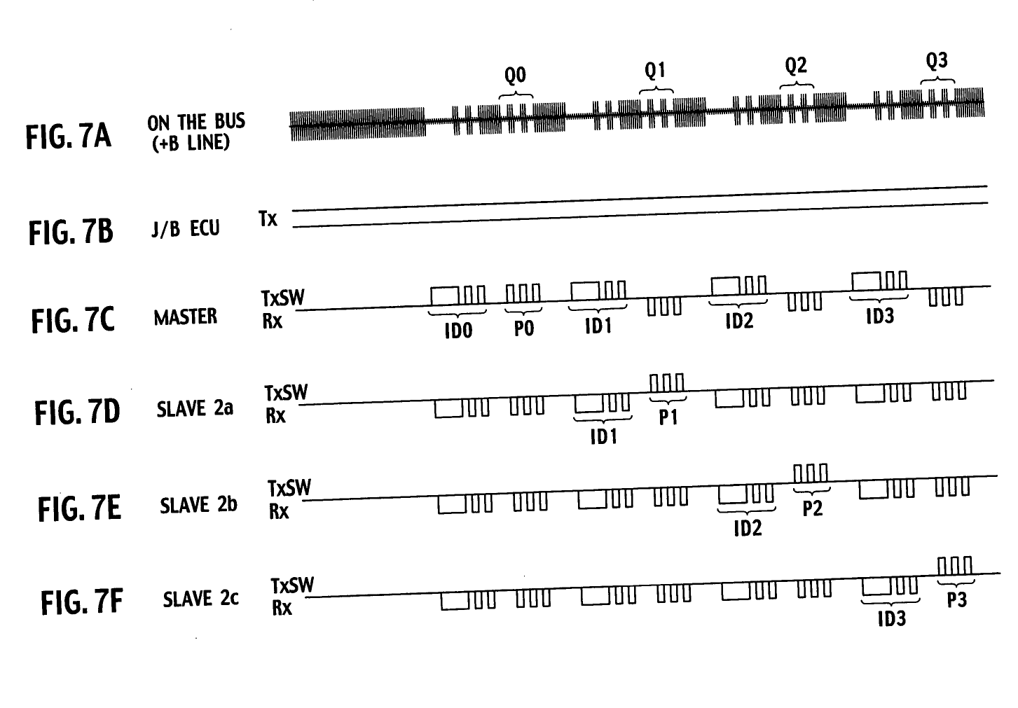

FIGS. 7A to 7F are timing charts of data transmission and reception of each of the J/B ECU 32, the master station ECU 1, and the slave station ECUs 2a to 2c. With reference to FIGS. 7A to 7F, a description will be given of the operations of the ASK communication device according to this embodiment.

FIG. 7A shows changes in carrier signals superimposed on the +B line of the bus line 3, FIG. 7B shows carrier signals output from the J/B ECU 32, that is, the carrier signal generator 32, FIG. 7C shows timing of data transmission and reception in the master station ECU 1, and FIGS. 7D to 7F show timing of data transmission and reception in each of the slave station ECUs 2a to 2c.

To the master station ECU 1, “ID0” is allocated as an identifier to identify each ECU, and also “ID1” to “ID3” are allocated to the slave station ECUs 2a to 2c, respectively. Therefore, when an ID signal specifying the identifier allocated to a certain slave station is outputted from the master station ECU 1, data is transmitted from the corresponding slave station in response to the signal.

As shown in FIG. 7B, the carrier signal generator 31 outputs carrier signals all the time to superimpose them on the bus line 3.

When ID=ID0 is set by the master station ECU 1, data transmission is made by the master station ECU1. Therefore, by switching the transmission switch 15 between ON and OFF states with timing as denoted by reference symbol P0 shown in FIG. 7C, carrier signals superimposed on the bus line 3 are not attenuated while the transmission switch 15 is OFF, but are attenuated while the transmission switch 15 is ON. As a result, the ON and OFF operations of the transmission switch 15 can cause ASK modulation of the carrier signals on the bus line 3.

Specifically, carrier signals have the waveforms as denoted by reference symbol Q0 of FIG. 7A. That is, transmission signals, which are the ASK-modulated signals representing “0” when the transmission switch 15 is ON and representing “1” when the transmission switch 15 is OFF, can be obtained from the master station ECU 1. The transmission data is received by each of the slave station ECUs 2a to 2c.

When a signal indicating ID1 is outputted from the master station ECU 1, the slave station ECU 2a recognizes that data transmission is made by the ECU 2a.

The transmission switch 25 of the slave station ECU 2a is then turned ON and OFF with timing denoted by reference symbol P1 of FIG. 7D. This causes changes in the amplitude of carrier signals superimposed on the bus line 3 through the attenuation process previously described, so that these carrier signals are modulated based on ASK. That is, the ASK-modulated signals as denoted by reference symbol Q1 of FIG. 7A can be obtained.

These ASK-modulated signals are sent as transmission data of the slave station ECU 2a to the master station ECU 1 and other slave station ECUs 2b and 2c.

Likewise, when a signal indicating ID2 is outputted from the master station ECU 1, carrier signals superimposed on the bus line 3 are modulated by the ON and OFF operations of the transmission switch 25 (see reference symbol P2) provided in the slave station ECU 2b. Accordingly, the ASK-modulated signals as denoted by reference symbol Q2 are superimposed on the bus line 3, and then fed to the master station ECU 1 and other slave stations ECU 2a and 2c.

When a signal indicating ID3 is outputted from the master station ECU 1, the ON and OFF operations of the transmission switch 25 are made as denoted by reference symbol P3 of FIG. 7F, and the ASK-modulated signals denoted by reference symbol Q3 are then superimposed on the bus line 3 and consequently fed to the master station ECU 1 and other slave station ECUs 2a and 2b.

In this manner, data transmission using ASK modulation can be established between the master station ECU 1 and the slave station ECUs 2a to 2c.

As described above, in the ASK communication device according to this embodiment, the bus line 3 for connecting the master station ECU 1 with the slave station ECUs 2a to 2c is also connected with the carrier signal generator 31, and carrier signals outputted therefrom are superimposed on the bus line 3 all the time. When data is transmitted from the master station ECU 1, the transmission switch 15 is turned ON and OFF to cause ASK modulation of carrier signals on the bus line 3. Accordingly, each of the slave station ECUs 2a to 2c can receive transmission data that is modulated based on ASK at the master station ECU 1.

Furthermore, when data is transmitted from the slave station ECUs 2a to 2c, just as in the case of the master station ECU1, carrier signals superimposed on the bus line 3 are modulated based on ASK by the ON and OFF operations of the transmission switch 25 in one of slave station ECUs 2a to 2c which corresponds to the ID designated by the master station ECU 1. Therefore, other slave station ECUs and the master station ECU 1 can receive data from the transmission source slave station.

With such a configuration as described above, only the carrier signal generator 31 has the oscillator circuit 33 (FIG. 3) for generating carrier signals, and the ECUs 1 and 2a to 2c do not need to have such an oscillator circuit, which leads to simplified circuitry of each of the ECUs 1 and 2a to 2c, and also reduces the cost thereof, because expensive oscillator circuits are not necessary.

In comparison between the master station ECU 1 and the slave station ECUs 2a to 2c, there is a difference only in that the master station ECU 1 makes control for determining a transmission source ECU, and the circuit configurations are the same therebetween. Therefore, the same circuits can be used for both the master station ECU 1 and the slave station ECU 2a to 2c, so that the number of circuit types can be reduced. Accordingly, the workability during assembling as well as maintainability is increased.

Furthermore, since carrier signals are always superimposed on the bus line 3, highly accurate and stable PLL control can be done, thereby increasing the communication quality.

### Modified Embodiments

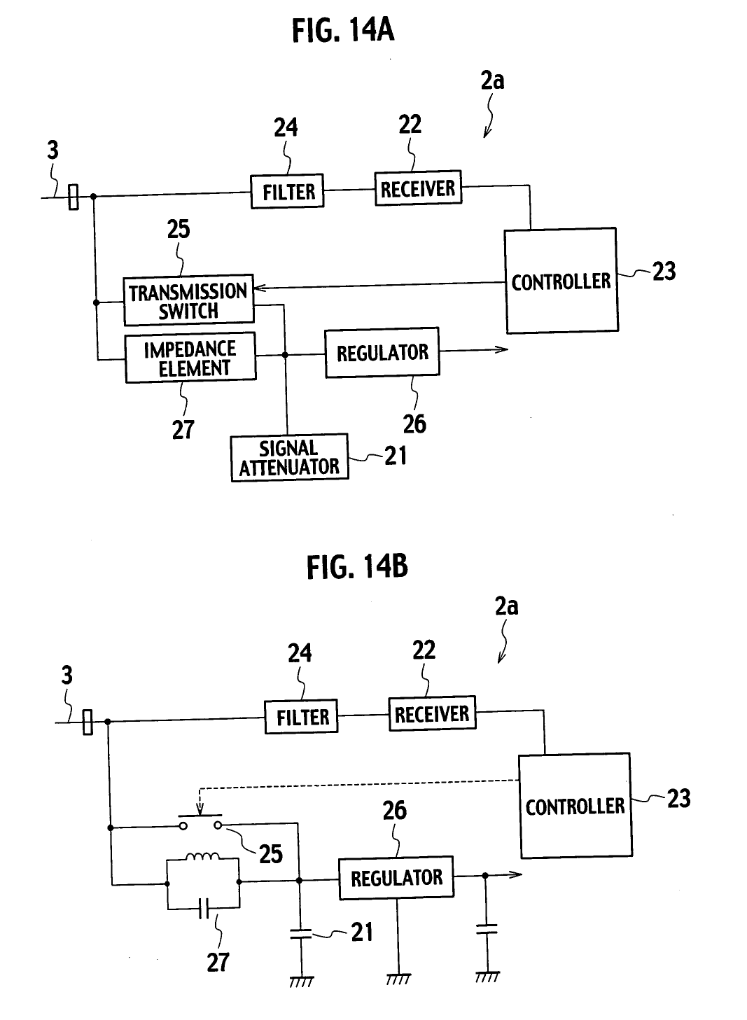

FIGS. 14A and 14B are explanatory diagrams showing the configuration of the slave station ECU 2a in its modification example, and FIG. 14A is a block diagram and FIG. 14B is a circuit diagram thereof. The slave station ECU 2a is provided with an impedance element 27 in parallel with the transmission switch 25, and is further provided with a regulator 26 at the connection of the transmission switch 25 and the signal attenuator 21. As shown in FIG. 14B, the impedance element 27 is a parallel circuit of a coil and capacitor.

According to this configuration, the power voltage supplied from the bus line 3 which functions as a power line is fed to the regulator 26 after high frequency signals used for ASK communication are eliminated by the impedance element 27. Therefore, the regulator 26 converts a voltage fed via the power line (for example, 12V) to a voltage (for example, 5V) used for driving the ECU and a load, and this converted voltage can be used to drive a load. In addition, carrier signals superimposed on the bus line 3 can be modulated based on ASK through the ON and OFF operations of the transmission switch 25.

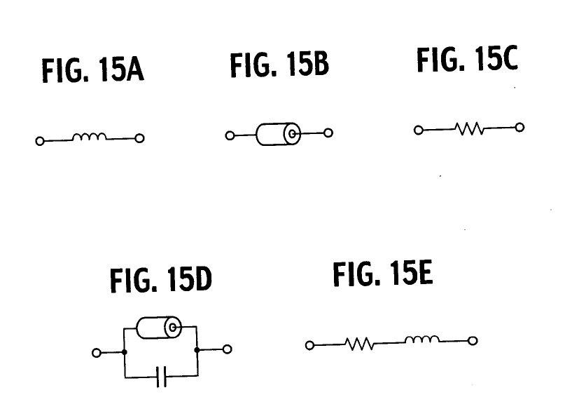

The impedance element 27 is not limited to the above described parallel circuit of a coil and capacitor, and the similar effect can be obtained when a coil shown in FIG. 15A, a ferrite bead shown in FIG. 15B, a resistor shown in FIG. 15C, a parallel circuit of a ferrite bead and capacitor shown in FIG. 15D, a series circuit of a resistor and coil shown in FIG. 15E, or the combinations thereof are used. The similar effect can be obtained when circuits other than the above which feature a low impedance at a carrier frequency are used.

### Second Embodiment

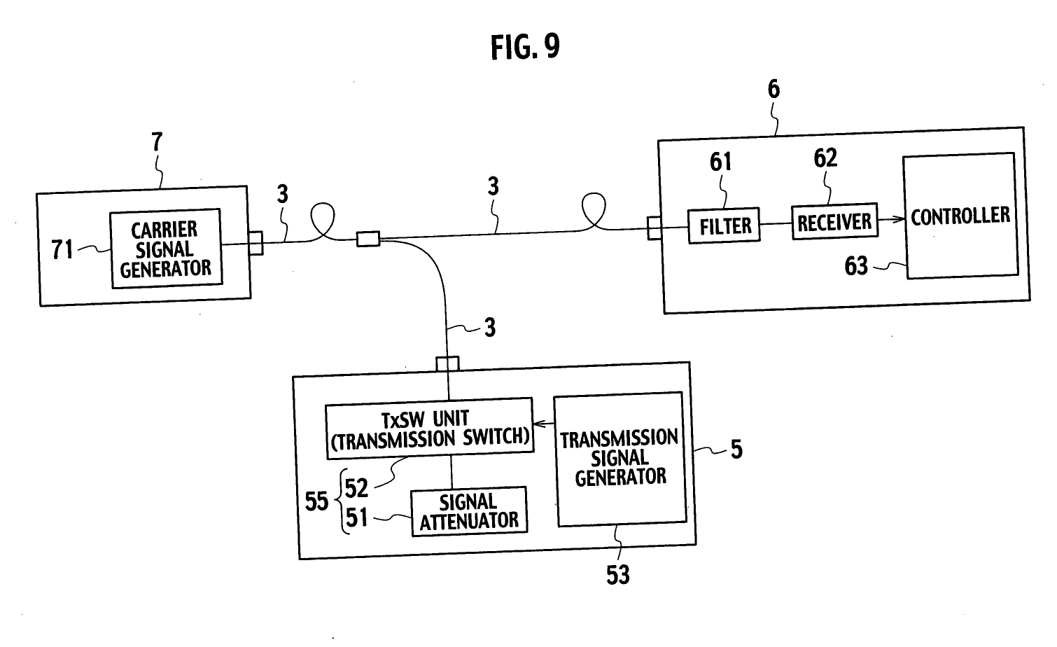

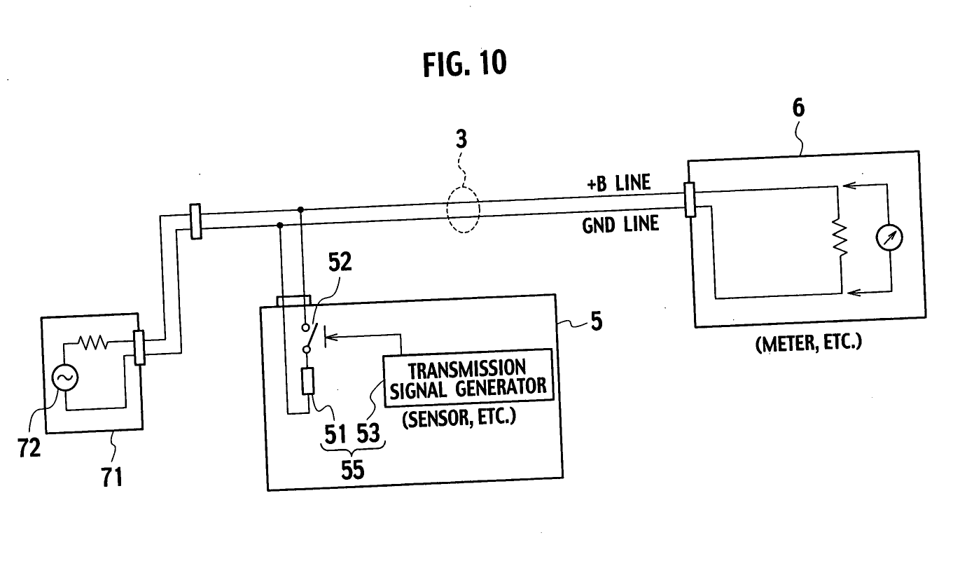

A second embodiment of the present invention will be described next. FIGS. 9 and 10 are a block diagram and a circuit diagram, respectively, showing the configuration of an ASK communication device according to the second embodiment of the present invention. As shown in FIGS. 9 and 10, the ASK communication device includes a transmitter ECU (transmitting station) 5, a receiver ECU (receiving station) 6, and a carrier signal generating ECU 7, all of which are connected to each other via a power line. As in the foregoing first embodiment, a technique of superimposing communication signals on the power line is employed, and therefore the power line serves as a bus line 3.

The carrier signal generating ECU 7 includes a carrier signal generator 71 for superimposing carrier signals on the bus line 3, and the carrier signal generator 71 has an oscillator circuit 72 (FIG. 10) for generating carrier signal at a predetermined frequency.

The transmitter ECU 5 includes a modulator 55 that achieves ASK modulation via the bus line 3, as shown in FIG. 10. More specifically, the transmitter ECU 5 includes a signal attenuator 51 provided between a +B line and ground line of the power line (bus line 3), and a transmission switch 52 that switches the signal attenuator 51 between ON and OFF states. The transmitter ECU 5 further includes a transmission signal generator 53 that generates a signal to be fed to the receiver ECU 6 and based on the signal, outputs an ON/OFF instruction signal to the transmission switch 52.

The receiver ECU 6 includes a receiver 62 that receives ASK-modulated data sent from the transmitter ECU 5 and demodulates the ASK-modulated data, a filter 61 that eliminates components within an unnecessary frequency band, and a controller 63 that controls the receiver 62 and a load (not shown) connected to the receiver ECU 6.

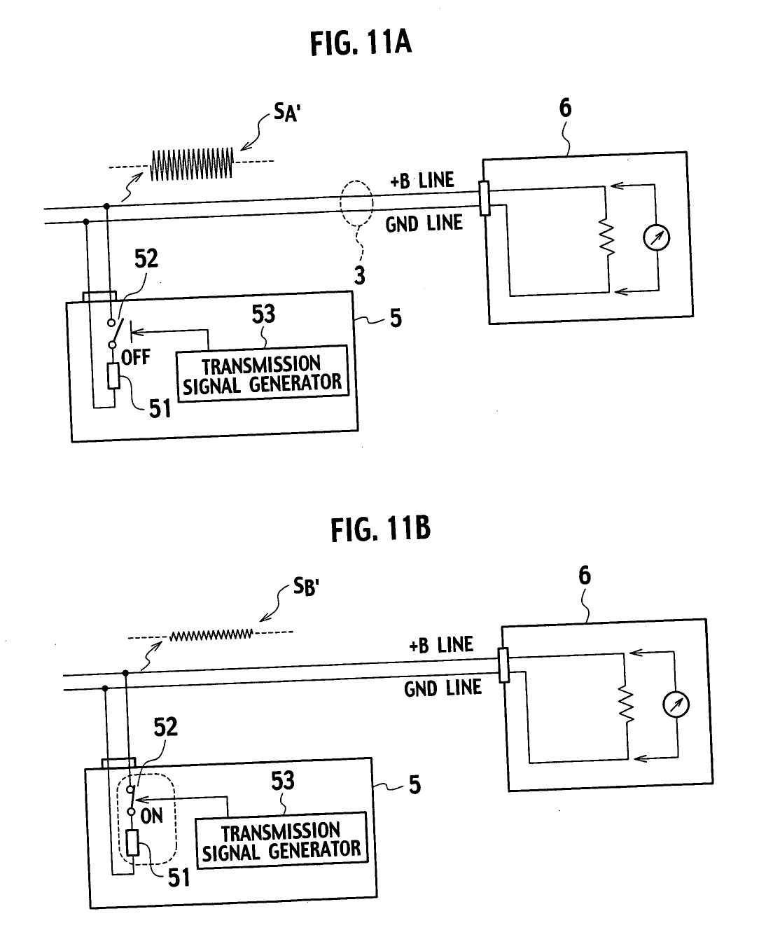

FIGS. 11A to 11B are explanatory diagrams showing operations of the transmission switch 52 performed when data is sent from the transmitter ECU 5 to the receiver ECU 6. FIG. 11A illustrates the case where “1” is represented. As shown in FIG. 11A, when the transmission switch 52 is turned OFF, the amplitude SA′ of carrier signals output from the carrier signal generator 71 shown in FIG. 9 and superimposed on the bus line 3 is maintained, so that “1” can be represented.

FIG. 11B illustrates the case where “0” is represented. When the transmission switch 52 is turned ON, the +B line and ground line are connected to each other via the signal attenuator 51, and thus carrier signals output from the carrier signal generator 71 and superimposed on the bus line 3 are attenuated, so that a small amplitude SB′ is obtained. Therefore, “0” can be represented consequently.

That is, without having an oscillator circuit for generating carrier signals and transmission means for modulating the carrier signals by ASK to output them to the bus line 3, the transmitter ECU 5 can send the ASK-modulated signals to the receiver ECU 6 through the ON and OFF operations of the transmission switch 52.

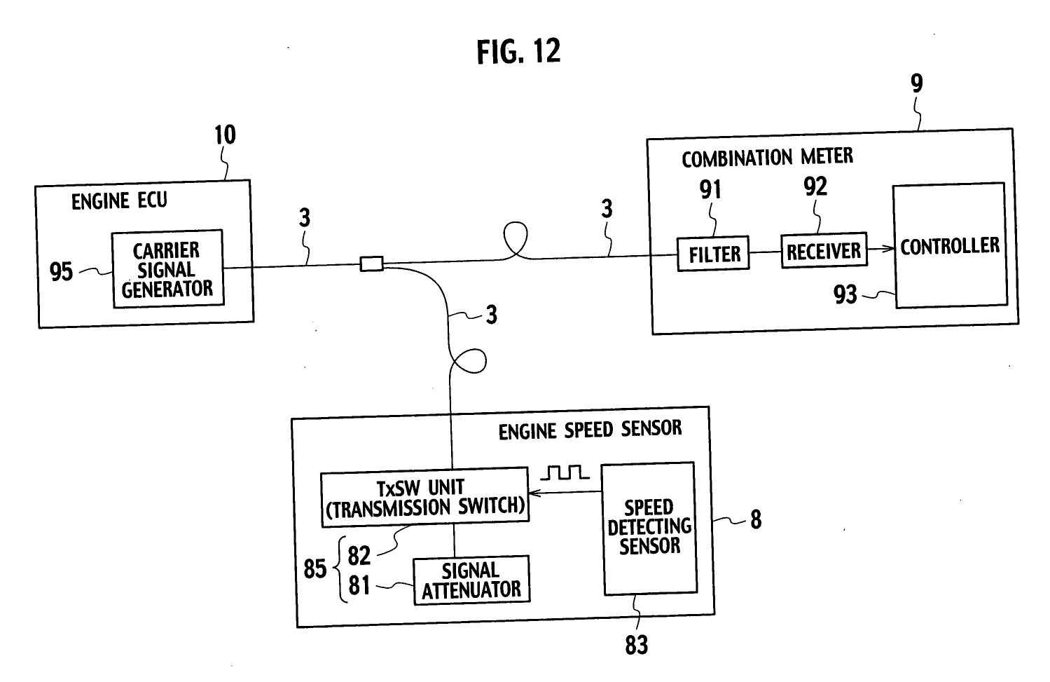

FIG. 12 is a block diagram showing an example of the ASK communication device according to the second embodiment and illustrates the configuration for transmitting an engine speed signal detected by an engine speed sensor 8 provided in a vehicle to a combination meter 9 via the power line (bus line 3).

As shown in FIG. 12, the engine speed sensor 8 and the combination meter 9 are connected to each other via the bus line 3, and the bus line 3 is also connected to a carrier signal generator 95 provided in an engine ECU 10 so that carrier signals output from the carrier signal generator 95 are superimposed on the bus line 3.

The engine speed sensor 8 includes a speed detecting sensor 83 that detects the number of engine revolutions and outputs a detection signal, and a modulator 85 having a transmission switch 82 and a signal attenuator 81. The combination meter 9 includes a filter 91, a receiver 92, and a controller 93.

With this configuration, an engine speed signal detected by the speed detecting sensor 83 is outputted as a signal indicating “1” or “0” to the transmission switch 82, and in synchronization with this signal, the transmission switch 82 is turned ON/OFF, causing ASK modulation of carrier signals superimposed on the bus line 3. The ASK-modulated data is sent to the combination meter 9, and thus the combination meter 9 can obtain the engine speed signal by demodulating the received ASK-modulated data.

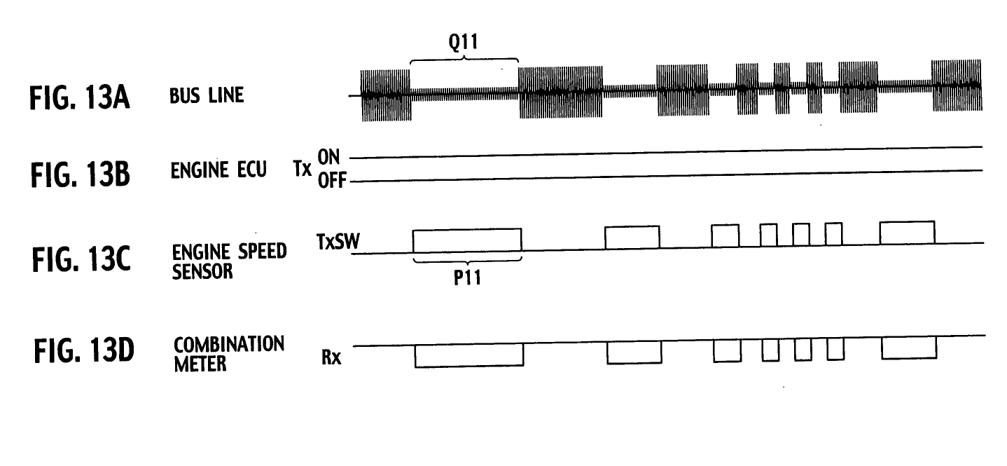

FIGS. 13A to 13D are timing charts of data transmission and reception of each of the engine ECU 10, engine speed sensor 8, and combination meter 9 shown in FIG. 12. With reference to FIGS. 13A to 13D, a description will be given of the operation of the ASK communication device according to this embodiment.

FIG. 13A shows changes in the amplitude of carrier signals superimposed on the +B line of the bus line 3, FIG. 13B shows carrier signals output from the engine ECU 10, that is the carrier signal generator 95, FIG. 13C shows transmission timing of the engine speed sensor 8, and FIG. 13D shows reception timing of the combination meter 9.

As shown in FIG. 13B, the carrier signal generator 95 of the engine ECU 10 are superimposing carrier signals on the bus line 3 all the time. When a signal of “1” or “0” indicating the number of engine revolutions is outputted from the speed detecting sensor 83 of the engine speed sensor 8, the transmission switch 82 is turned ON or OFF in synchronization with the signal.

When the transmission switch 82 is OFF, carrier signals superimposed on the bus line 3 are not attenuated, but when the transmission switch is ON, two electric wires of the bus line 3 (i.e., +B line and ground line composing the power line) are connected to each other via the signal attenuator 81, and consequently the carrier signals are attenuated. That is, as denoted by reference symbol Q11 of FIG. 13A, the amplitude of the carrier signals on the bus line 3 are attenuated while the transmission switch 82 is ON as denoted by reference symbol P11 of FIG. 13C.

Therefore, the ON/OFF operations of the transmission switch 82 cause ASK modulation of carrier signals, and then the modulated signals are received by the combination meter 9, which is followed by ASK demodulation at the receiver, 92. Accordingly, data of the number of engine revolutions can be obtained by the combination meter 9.

In this manner, data communication using ASK modulation can be established between the engine speed sensor 8 operative as a transmitter ECU and the combination meter 9 operative as a receiver ECU.

As described above, in the ASK communication device according to this embodiment, the bus line 3 for connecting the transmitter ECU 5 (see FIG. 9) and the receiver ECU 6 with each other is also connected to the carrier signal generator 71 which superimposes carrier signals on the bus line 3 all the time. When data is sent from the transmitter ECU 5, the transmission switch 52 is turned ON and OFF to cause ASK modulation of carrier signals superimposed on the bus line 3. The receiver ECU 6 can receive the transmission data that is modulated based on ASK at the transmitter ECU 5.

In this embodiment, carrier signals are outputted from the oscillator circuit 72 provided in the carrier signal generator 71, and neither the transmitter ECU 5 nor the receiver ECU 6 has such an oscillator circuit. The circuits can be downsized accordingly, and the cost thereof can be reduced.

Furthermore, as shown in FIG. 12, the ASK communication device is used for one-way communication from the engine speed sensor 8 to the combination meter 9. Therefore, the data transmitting side of engine speed sensor 8 does not need to have therein a receiver, and the data receiving side of combination meter 9 does not need to have therein a modulator 85 as transmission means, that is, the transmission switch and signal attenuator. This can further reduce the size of circuitry, which leads to a cost reduction.

While the ASK communication device of the present invention has been described in the context of the preferred embodiments shown and discussed, it is to be understood that the present invention is not limited thereto, and each component is replaceable with any other components having the same function.

For example, the foregoing embodiments have dealt with the case where the ASK communication device of the present invention is used for communication between ECUs provided in a vehicle. The present invention is not, however, limited thereto and is applicable to other types of communications.

Furthermore, while the foregoing embodiments have dealt with the case where a power line is used as the bus line 3 to connect the ECUs with each other, the present invention is not limited to this case and is applicable to the case where an electric wire dedicated to a bus line is used to establish communication.

### ADVANTAGES OF THE INVENTION

According to the first aspect of the present invention, a carrier signal generator is connected to a bus line for connecting communication stations with each other, and carrier signals output from the carrier signal generator are superimposed on the bus line. A transmission source communication station controls attenuation and non-attenuation of the carrier signals by controlling an attenuator operable as a modulator, thereby to cause ASK modulation of those carrier signals. Other communication stations receive and demodulate the ASK-modulated data to obtain data transmitted from the transmission source communication station. In this manner, communication between communication stations using an ASK scheme can be assuredly achieved.

Only the carrier signal generator has an oscillator circuit for outputting carrier signals, and the communication stations each do not have such an expensive oscillator circuit as a crystal oscillator, ceramic oscillator, and PLL circuit. Accoedingly, the circuitry is downsized and a cost reduction can be made.

Furthermore, since the attenuator has a transmission switch and an impedance element operable as an attenuator, a remarkably simple technique, such as ON/OFF operations of the transmission switch, allows the control of attenuation and non-attenuation of carrier signals, thereby achieving stable control.

According to the second aspect of the present invention, a carrier signal generator is connected to a bus line for connecting a transmitting station and a receiving station with each other, and carrier signals output from the carrier signal generator are superimposed on the bus line. The transmitting station then controls attenuation and non-attenuation of the carrier signals by operating an attenuator to cause ASK modulation of the carrier signals. The receiving station receives and demodulates the ASK-modulated data thereby to obtain data transmitted from the transmitting station. In this manner, data transfer from the transmitting station to the receiving station can be achieved with high reliability.

Only the carrier signal generator has therein an oscillator circuit for outputting carrier signals, and neither the transmitting station nor the receiving station does not have such an expensive oscillator circuit as a crystal oscillator, ceramic oscillator, and PLL circuit, so that the circuit size is reduced, thereby leading to a cost reduction.

Furthermore, since the attenuator has a transmission switch and an attenuator, the control of attenuation and non-attenuation of the carrier signals can be made by a remarkably simple technique, such as ON/OFF control of the transmission switch, so that stable control can be achieved.

Furthermore, according to the present invention, a power line for power voltage supply is used for a bus line for communication, which enables ASK communication without a dedicated line and also simplifies the circuit configuration.

### INDUSTRIAL APPLICABILITY

The ASK communication device of the present invention is remarkably useful to reduce the device size in data communication between ECUs provided in a vehicle.

This application claims benefit of priority under 35USC §119 to Japanese Patent Applications No. 2004-221987, filed on Jul. 29, 2004, the entire contents of which are incorporated by reference herein. Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

What is claimed is:

1. An ASK communication device having a plurality of communication stations being connected with each other via a bus line and establishing data communication between the communication stations using an ASK modulation scheme, comprising:
a carrier signal generator being connected to the bus line, the carrier signal generator outputting carrier signals to the bus line, wherein
each of the communication stations includes:
a modulator that transmits data by ASK modulation of attenuating the carrier signals being superimposed on the bus line with predetermining timing; and
a receiver that receives data being transmitted from other communication stations via the bus line, and
one of the communication stations outputs an identification signal of a particular communication station via the bus line, and the particular communication station designated by the identification signal transmits data.

2. The ASK communication device according to claim 1, wherein
the modulator is a series circuit of a switch and an attenuator and is connected with two electric wires of the bus line, and
the carrier signals superimposed on the bus line are alternatively attenuated or non-attenuated by turning the switch ON and OFF.

3. The ASK communication device according to claim 2, wherein the attenuator is an impedance element.

4. The ASK communication device according to claim 1, wherein the bus line is a power line used for supplying power source voltage.

5. An ASK communication device establishing data communication via a bus line, comprising:
a carrier signal generator connected to the bus line, the carrier signal generator outputting carrier signals to the bus line;
a transmitting station that transmits data by ASK modulation of attenuating the carrier signals superimposed on the bus line with predetermining timing; and
a receiver that receives the data transmitted from the transmitting station via the bus line.

6. The ASK communication device according to claim 5, wherein
the transmitting station is a series circuit of a switch and an attenuator, and is connected with two electric wires composing the bus line, and
the carrier signals superimposed on the bus line are switchably attenuated and unattenuated by turning the switch ON and OFF.

7. The ASK communication device according to claim 6, wherein the attenuator is an impedance element.

8. The ASK communication device according to claim 5, wherein the bus line is a power line used for supplying power source voltage.
